(19) United States
(12) Patent Application Publication
(10) Pub. No.: US 2008/0225727 A1
(43) Pub. Date: Sep. 18, 2008

(54) COMMUNICATION SYSTEM AND ROUTER

(76) Inventors: Hitoshi YOSHIDA, Yokohama (JP); Hirofumi Masukawa, Isehara (JP); Kazuma Yumoto, Fuchu (JP); Kazuhiro Kusama, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/038,902

(22) Filed: Feb. 28, 2008

(30) Foreign Application Priority Data
Mar. 13, 2007 (JP) 2007-063266

(51) Int. Cl. G01R 31/08

(52) U.S. Cl. 370/236

(57) ABSTRACT

A router checks traffic with respect to the SIP server at reception of a request message addressed to an SIP server from an SIP terminal. If the traffic exceeds a band allocated to the SIP server, the router transfers the request message to a congestion server.

### INCORPORATION BY REFERENCE

The present application claims priority from Japanese application JP 2007-063266 filed on Mar. 13, 2007, the content of which is hereby incorporated by reference into this application.

### BACKGROUND OF THE INVENTION

The present invention relates to a technique to control congestion on an Internet Protocol (IP) network.

For example, JP-A 2005-167769 describes a technique to control congestion on an IP network. According to the technique, a congestion controller is installed for each session processing server such that if the congestion controller detects a congestion state, processing is distributed to another session processing server.

### SUMMARY OF THE INVENTION

According to the technique, it is required to install a congestion controller for each session processing server. In addition, if a session setup request is transmitted exceeding processing performance of the congestion controller, processing is delayed or stopped in the congestion controller or the session processing server, and the system cannot set up any session.

It is therefore an object of the present invention to provide a technique to easily prevent occurrence of the congestion state.

To remove the problem according to the present invention, a call control server and a congestion server are connected to a relay unit such that if a call request is issued exceeding a predetermined band assigned to the call control server, the request is transferred to the congestion server and the congestion server issues a congestion notification (error notification).

For example, the present invention is a communication system including a call control server to conduct call control for a call request from a terminal, a congestion server, and a router. The router calculates traffic with respect to the call control server. At reception of a request message addressed to the call control server from the terminal, if the traffic exceeds a band beforehand set to the call control server, the router transfers the request message to the congestion server. The congestion server transmits an error response message to the terminal in reply to the request message.

According to the present invention, it is therefore possible to provide a technique to easily prevent occurrence of the congestion state.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an outline of an embodiment of a communication system according to the present invention;

FIG. 2 is a diagram showing an outline of an embodiment of a router according to the present invention;

FIG. 3 is a diagram showing a layout of a session table in the embodiment;

FIG. 4 is a diagram showing a configuration of a computer in the embodiment;

FIG. 5 is a diagram showing a configuration of a congestion server in the embodiment;

FIG. 6 is a diagram showing structure of a computer in the embodiment;

FIG. 7 is a diagram showing a configuration of an SIP terminal in the embodiment;

FIG. 8 is a sequence chart showing processing in the embodiment of a communication system according to the present invention;

FIG. 9 is a sequence chart showing processing in the embodiment;

FIG. 10 is a flowchart showing processing of the router in the embodiment;

FIG. 11 is a flowchart showing processing of the congestion server in the embodiment; and

FIG. 12 is a diagram showing an embodiment of a communication system according to the present invention.

### DESCRIPTION OF THE EMBODIMENTS

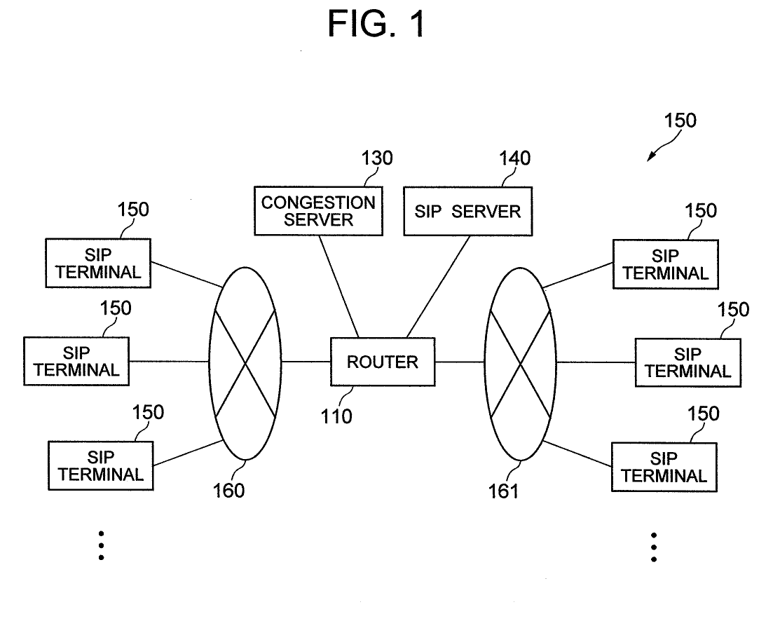

FIG. 1 shows an outline of an embodiment of a communication system 100 according to the present invention.

As FIG. 1 shows, the communication system 100 includes a router 110, a congestion server 130, an Session Initiation Protocol (SIP) server 140, and SIP terminals 150. The router 110 relays data on a first network 160 and a second network 161. The SIP server 140 is a server to conduct ordinary call control conforming to the SIP. That is, a known server is available as the SIP server 140 and hence detailed description thereof will be avoided.

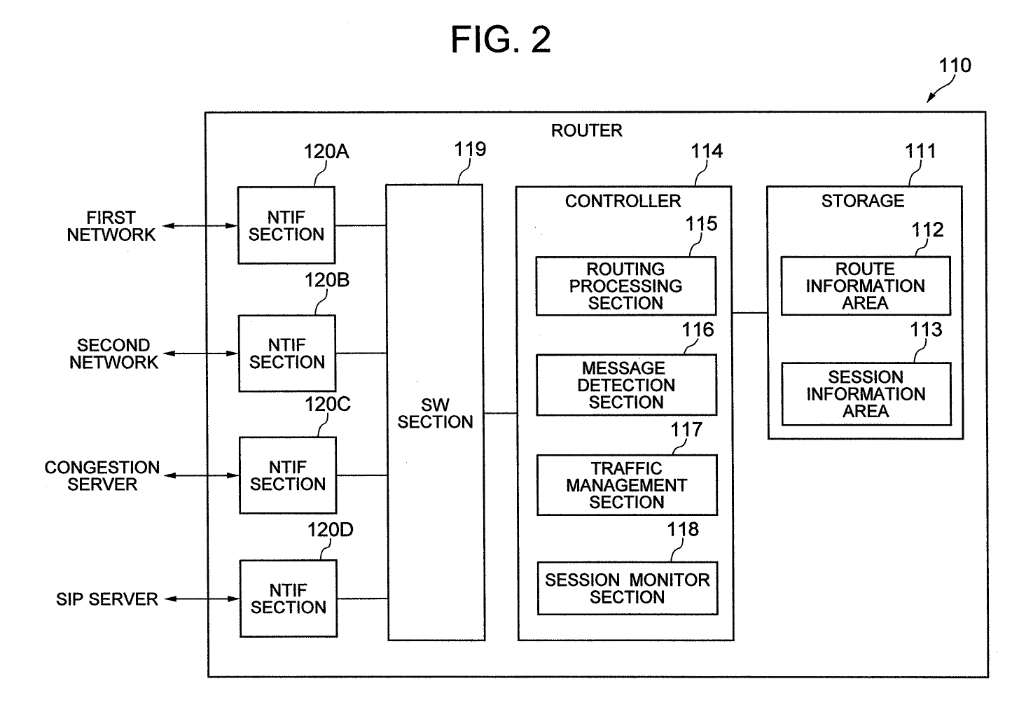

FIG. 2 shows an outline of a configuration of the router 110.

As FIG. 2 shows, the router 110 includes a storage 111, a controller 114, a SWitching (SW) section 119, and Network InterFace (NTIF) sections 120A to 120D.

The storage 111 includes a route information area 112 and a session information area 113.

The route information area 112 is disposed to store therein route information to be used by a routing processing section 115 for routing processing, which will be described later. The route information is route information widely known and hence detailed description thereof will be avoided.

The session information area 113 is employed to store therein information to identify a session with the SIP server 140.

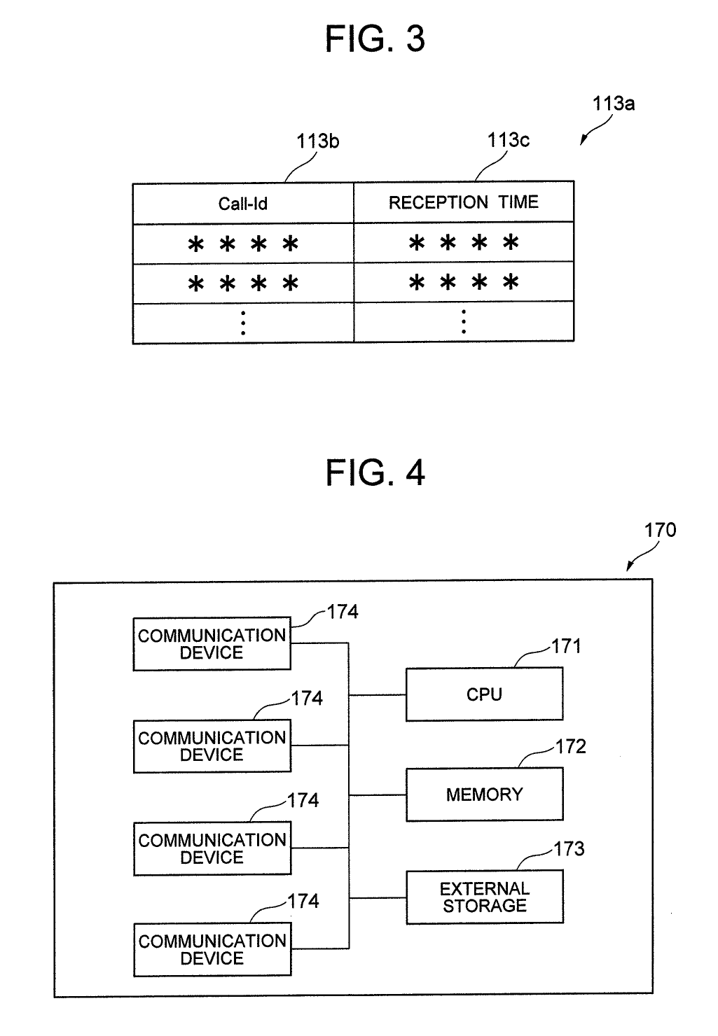

In the embodiment, there is stored, for example, a session table 113a shown in FIG. 3 (outline of the table 113a).

As shown in FIG. 3, the session table 113a includes a Call-Id field 113b and a reception time field 113c.

The Call-Id field 113b is used to store therein Call-Id which is identification information to identify each call on the SIP.

The reception time field 113c is employed to store information identifying a point of time when the router 110 receives a call request identified by Call-Id stored in the Call-Id field 113b. In the embodiment, a point of time when each entry is created in the session table 113 is stored in the reception time field 113c.

Returning to FIG. 2, the controller 114 includes a routing processing section 115, a message detection section 116, a traffic management section 117, and a session monitor section 118.

The message detection section 116 analyzes data received by the NTIF sections 120A to 120D to detect a request message addressed to the SIP server 140.

If the message detection section 116 detects a request message addressed to the SIP server 140, the traffic management section 117 executes processing for the message. Any other data is processed by the routing processing section 115.

The routing processing section 115 executes relay processing (routing) by use of route information stored in the route information area 112. The processing of the routing processing section 115 is similar to that executed by the known router and hence detailed description thereof will be avoided.

The traffic management section 117 controls a communication state (band) with respect to the SIP server 140.

For example, according to the embodiment, if a notification of detection of a request message addressed to the SIP server 140 is received from the message detection section 116, the traffic management section 117 determines the amount of data of the request message. By totaling the amounts of data at a predetermined interval of time, the traffic management section 117 calculates traffic with respect to the SIP server 140.

If the calculated traffic is equal to or less than a predetermined threshold value, the traffic management section 117 transfers the request message to the SIP server 140.

After the request message is transferred to the SIP server 140, the traffic management section 117 notifies the session monitor section 118 of Call-Id of the message to request registration of the Call-Id.

If the calculated traffic exceeds the predetermined threshold value, the traffic management section 117 issues a query including Call-Id to the session monitor section 118 to determine whether or not the request message addressed to the SIP server 140 is associated with an existing session. If the message is associated with an existing session, the traffic management section 117 transfers the request message to the SIP server 140. Otherwise, the traffic management section 117 transfers the request message to the congestion server 130.

The session monitor section 118 controls the session table 113a stored in the session information area 113.

Specifically, if a query including Call-Id is received from the traffic management section 117, the session monitor section 118 makes a check to determine whether or not the Call-Id exists in the session table 113a stored in the session information area 113 and then returns a reply of presence or absence of the Call-Id.

If the Call-Id is absent, the session monitor section 118 creates a new entry in the session table 113a, and then stores the Call-Id in a Call-Id field 113b of the entry and a point of time when the new entry is created in a reception time field 113c of the table 113a.

The session monitor section 118 monitors the reception time field 113c of each entry. If a predetermined period of time lapses relative to the time in the field 113c, the session monitor section 118 deletes the pertinent entry.

The SW section 119 conducts a switching operation to transfer data via the NFIF sections 120A to 120D. The switching may be carried out by hardware or software.

The NFIF sections 120A to 120D are interfaces to communicate information via networks.

In the embodiment, the NFIF sections 120A to 120D are connected respectively to the first network 160, the second network 161, the congestion server 130, and the SIP server 140.

Each of the NFIF sections 120A to 120D is provided with a shaper to control a band of a communication line connected thereto.

The router 100 constructed as above is implementable using a computer 170 shown in FIG. 4 (outline of the computer 170).

The computer 170 includes a Central Processing Unit (CPU) 171, a memory 172, an external storage 173, and communication units 174 including a Network Interface Card (NIC) to connect to a communication network.

The storage 111 is implementable by using the external storage 173. The controller 114 may be realized by executing a predetermined program loaded from the external storage 173 in the memory 173. The NFIF sections 120A to 120D may be implemented using the communication units 174. Each communication unit 174 includes a buffer memory to execute the shaper processing.

The router 100 need not be necessarily implemented by executing a program by the computer 170 as above. For example, the processing may be hardwarewise executed, for example, by an integrated logic chip such as an Application Specific Integrated Circuit (ASIC) or a Field Programmable Gate Array (FPGA). Alternatively, the processing may be softwarewise executed, for example, by a computer such as a Digital Signal Processor (DSP).

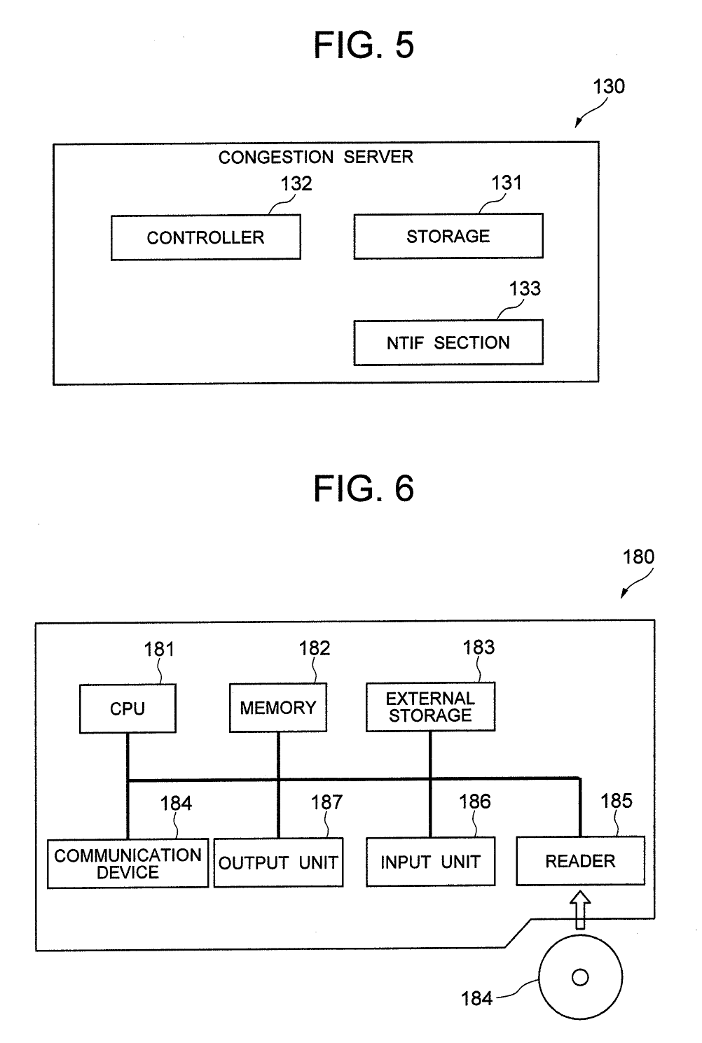

FIG. 5 shows an outline of structure of the congestion server 130.

As can be seen from FIG. 5, the congestion server 130 includes a storage 131, a controller 132, and an NTIF section 133.

The storage 131 is arranged to store therein data required for the processing in the congestion server 130.

The controller 132 supervises processing in which a congestion notification message is created as a response to the request message addressed to the SIP server 140 and received from the router 110 and the congestion notification message is then returned via the NTIF section 133.

In the embodiment, the congestion notification message includes, for example, a request mistake (or error) associated with the SIP 400s (a range from 400 to 499), request failure associated with the SIP 500s (a range from 500 to 599), or a global error response associated with the SIP 600s (a range from 600 to 699).

According to the embodiment, the congestion notification message includes time information identifying a point of time. The SIP terminal 150 having received such congestion notification message stops the request processing in conformity with the SIP for a period of time determined by the time information of the message.

The time information is stored in an appropriate area in the response message prescribed by the SIP. For example, the information may be added to an area to store a reply reason.

The NTIF section 133 is an interface to communicate information via a network.

The congestion server 130 may be implemented using, for example, a general computer 180 shown in FIG. 6 (an outline thereof). The computer 180 includes a CPU 181, a memory 182, an external storage 183 such as a Hard Disk Drive (HDD), a reader 185 to read information from a portable storage medium 184, e.g., a Compact Disk Read-Only Memory (CD-ROM) or a Digital Versatile Disk Read-Only Memory (DVD-ROM), an input unit 186 including a keyboard and/or a mouse, an output unit 187 such as a display, and a communication unit 188 such as an NIC to connect to a communication network.

For example, the storage 131 is implementable by the external storage 183, the controller 132 may be implemented through an operation in which a predetermined program stored in the external storage 183 is read therefrom to be loaded in the memory 182 and is then executed by the CPU 181, and the NTIF section 133 may be realized by the communication unit 185.

The predetermined program may be obtained via the reader 185 from the storage medium 184 or via the communication unit 188 from a network to be downloaded in the external storage 183. The program is then loaded therefrom in the memory 182 to be executed by the CPU 181. Or, the program may be directly loaded from the storage medium 184 via the reader 185 in the memory 182 or from a network via the communication unit 188 therein to be executed by the CPU 181.

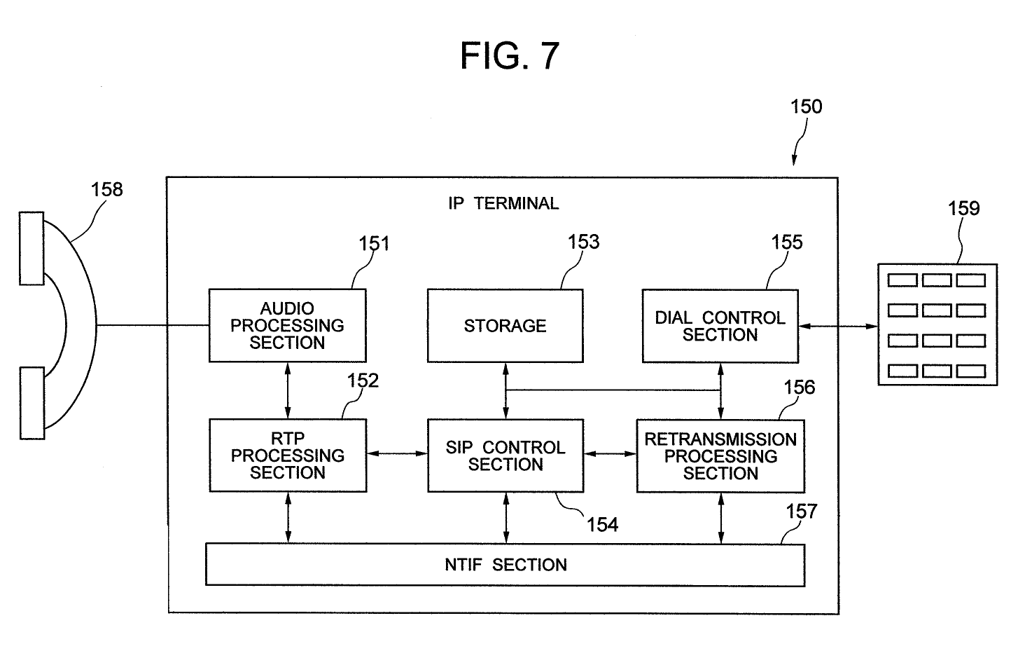

FIG. 7 shows an outline of the SIP terminal 150.

As shown in FIG. 7, the SIP terminal 150 includes an audio processing section 151, a Real Time Protocol (RTP) processing section 152, a storage 153, an SIP control section 154, a dial control section 155, a retransmission processing section 156, an NTIF section 157, a handset 158, and a dial module 159.

The audio processing section 151 samples and encodes audio signal inputted via a microphone, not shown, of the handset 158 and transmits a resultant audio signal to the RTP processing section 152.

Also, the audio processing section 151 decodes an audio signal received from the RTP processing section 152 to send a decoded signal to a speaker, not shown, of the handset 158.

The RTP processing section 152 executes processing in conformity with the RTP.

For example, the RTP processing section 152 processes the audio signal from the audio processing section 151 to create an RTP packet including the audio signal and then transmits the RTP packet to the NTIF section 157, the RTP packet being addressed to an IP address notified from the SIP control section 154.

The RTP processing section 152 restores the audio signal in the RTP packet sent from the NTIF section 157 to send the resultant signal to the audio processing section 151.

The storage 153 stores an IP address of the SIP server 140 to carry out call control.

The SIP control section 154 conducts call control according to the SIP.

For example, if an extension number of a destination is received via the dial module 159 from the user of the SIP terminal 150, the SIP control section 154 receives the extension number from the dial control section 155 to create a connection request (INVITE) message including the extension number and sends the message via the NTIF section 157 to the SIP server 140.

The dial control section 155 controls a signal inputted from the dial module 159.

The retransmission processing section 156 supervises operation in which time information is extracted from a predetermined field of the congestion notification message received from the NTIF section 157 to stop processing in the SIP control section 154 for a period of time determined according to the time information. In a situation wherein the processing in the SIP control section 154 is stopped, it is favorable to notify the user of the condition, for example, by producing a sound from the speaker of the handset 158.

The NTIF section 157 is an interface to communicate information via a network.

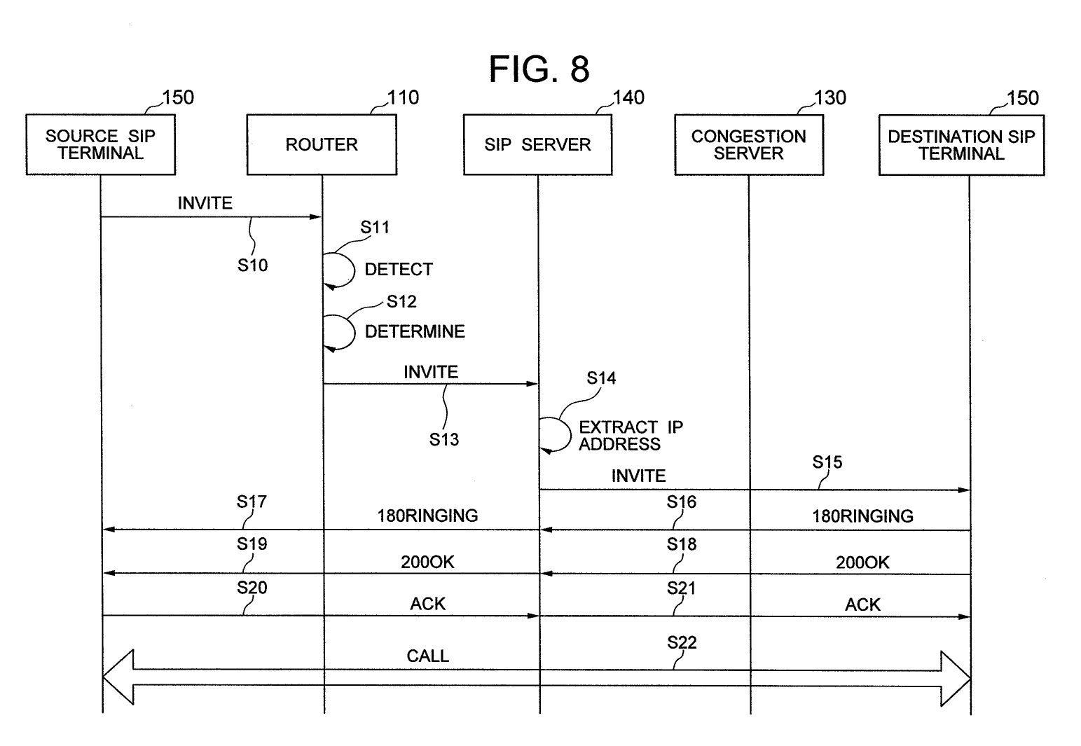

FIG. 8 shows a processing sequence of the communication system 100. This is a sequence of processing when no congestion exists on the communication path to the SIP server 140.

First, the SIP terminal 150 as a source sends to the SIP server 140 a request message, i.e., an INVITE message including a telephone number of the SIP terminal 150 as a destination (S10).

When the INVITE message is received, the router 110 recognizes by the message detection section 116 detection of the INVITE message (S11). The traffic management section 117 then calculates traffic with respect to the SIP server 140 to determine whether or not the traffic exceeds a predetermined threshold value (S12). Assume in this situation that the traffic is equal to or less than the predetermined threshold value. The router 110 hence transfers the message via the SW section 119 and the NTIF section 120D to the SIP server 140 (S13).

The SIP server 140 extracts, using register information, the IP address of the SIP terminal 150 on the basis of the telephone number in the INVITE message (S14) and transmits the message to the IP address (S15).

The destination SIP terminal 150 having received the message returns via the SIP server 140 a response message “180Ringing” indicating a calling state (S16, S17). If the SIP terminal 150 enters a call receivable state, for example, because the user has lifted up the handset, a response message of “200OK” is sent via the SIP server to the source SIP 150 (S18, S19).

When a response message of “ACK” is sent from the source SIP terminal 150 via the SIP server 140 to the destination SIP terminal 150 (S20, S21), the call is carried out (S22).

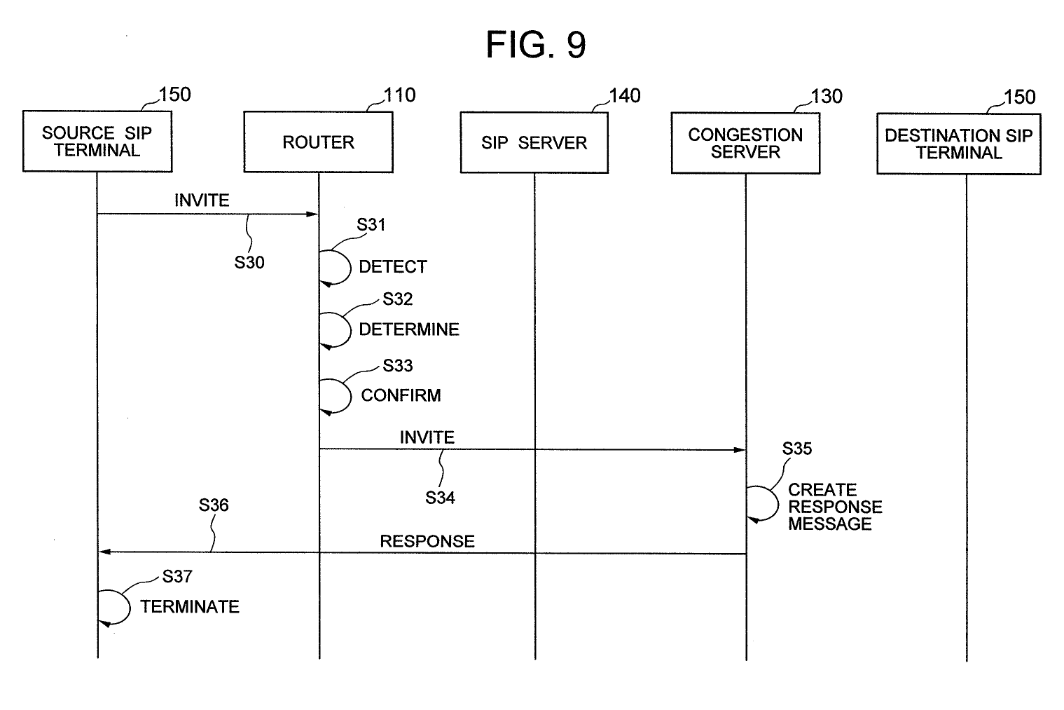

FIG. 9 shows a sequence of processing in the communication system 100. This processing is executed when congestion occurs on the communication path to the SIP server 140.

The source SIP terminal 150 first transmits to the SIP server a request message, i.e., an INVITE message including a telephone number of the destination SIP terminal 150 (S30).

When the message is received, the router 110 recognizes by the message detection section 116 that the message is an INVITE message (S31). The traffic management section 117 calculates traffic with respect to the SIP server 140 to determine whether or not the traffic exceeds a predetermined threshold value (S12). Assume that the traffic exceeds the predetermined threshold value in this situation.

The traffic management section 117 sends a query including Call-Id of the INVITE message to the session monitor section 118 to determine whether or not a session has already been established. The session monitor section 118 returns a response indicating whether or not such session has already been established (S33). Assume in this situation that a session has not been established.

The traffic management section 117 transfers the INVITE message via the SW section 119 and the NTIF section 120D to the congestion server 140 (S34).

The controller 132 of the congestion server 140 creates a congestion notification message by adding predetermined time information to a response message in reply to the INVITE message and transmits the congestion notification message to the source SIP terminal 150 (S36).

When the message is received, the SIP terminal 150 stops by the retransmission processing section 156 the processing in the SIP control section 154 for a period of time determined by the time information (S37).

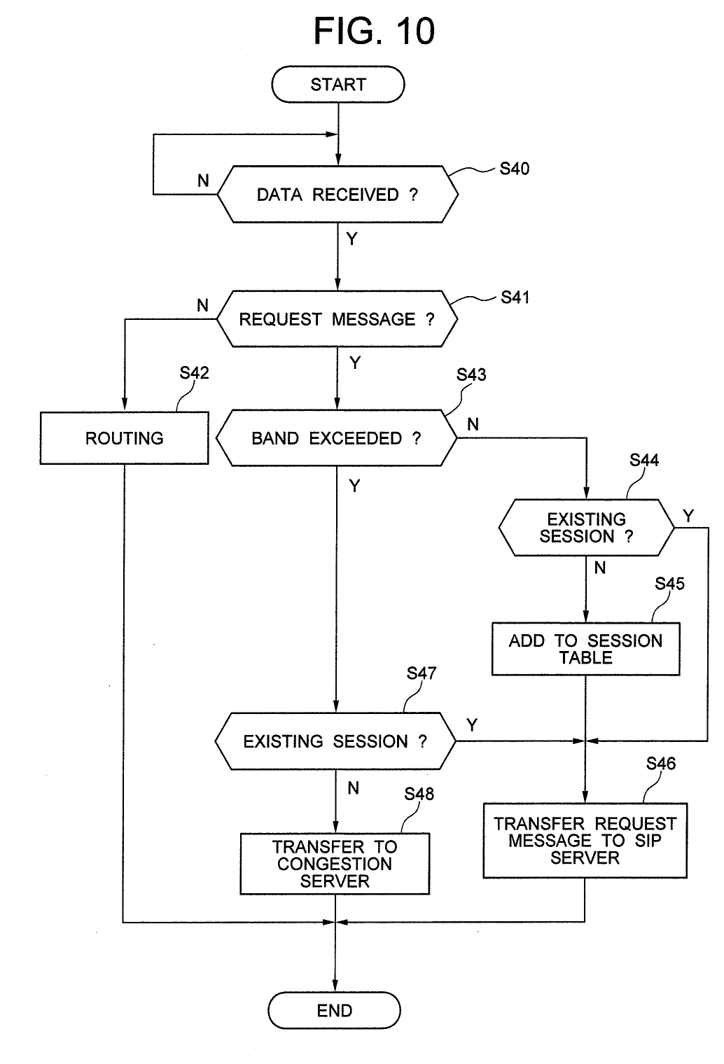

FIG. 10 shows processing of the router 110 in a flowchart.

When the router 110 receives data via the NTIF section 120A or 120B (S40), the message detection section 116 of the router 110 makes a check to determine whether or not the data is a request message to the SIP server 140 (S41).

If it is determined in step S41 that the data is other than a request message, the routing section 116 conducts a routing operation (S42) to thereby terminate the processing.

On the other hand, if it is determined in step S41 that the data is a request message to the SIP server 140, the traffic management section 117 calculates traffic to determine whether or not the traffic exceeds a preset threshold value, the threshold value determining whether or not the traffic exceeds particular traffic on a band beforehand set to the SIP server 140 (S43).

If the threshold value is not exceeded in step S43, the traffic management section 117 sends a query including Call-Id of the request message to the session monitor section 118 to determine whether or not a session has been established (S44).

If it is determined in step S44 that such session has not been established, the session monitor section 118 creates a new entry in the session table 113a to store therein Call-Id and a point of time when the entry is created (S45).

If it is determined in step S44 that such session has been established or if new information has been stored in the session table 113a in step S45, control goes to step S46.

In step S46, the traffic management section 117 transfers the request message via the SW section 119 and the NTIF section 120D to the SIP server 140.

If the threshold value is exceeded in step S43, the traffic management section 117 sends a query including Call-Id of the request message to the session monitor section 118 to determine whether or not a session has been established (S44). If such session has already been established, control goes to step S46.

If such session has not been established, the traffic management section 117 transfers the request message to the congestion serve 130 (S48).

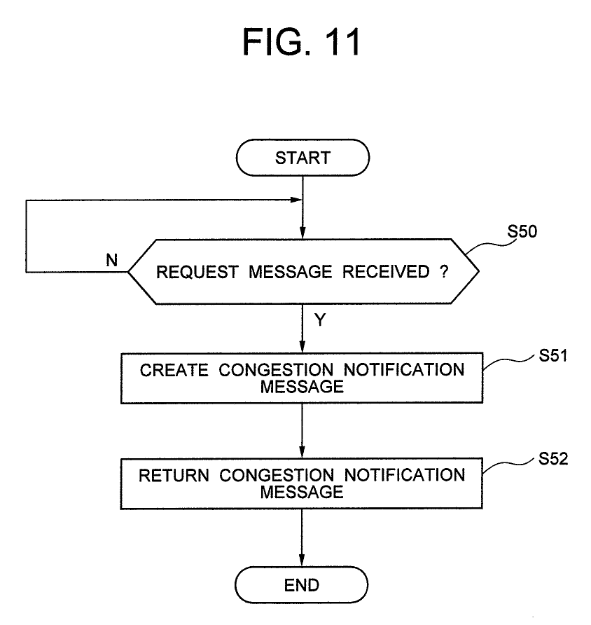

FIG. 11 shows processing of the congestion server 130 in a flowchart.

In the congestion server 130, when the request message is received via the NTIF section from the router 140 (S50), the controller 132 creates a congestion notification message by adding time information determining a period of time to a response message in reply to the request message (S51) and then returns the congestion notification message to the source SIP terminal 150 of the request message (S52).

According to the embodiment, even in a situation wherein an unexpectedly large number of call control request messages are concentrated onto the SIP server 140, for example, as in a disaster, each of the request messages exceeding a predetermined band is allocated from the router 110 to the congestion server 130 to be processed by the server 130. This advantageously prevents the system down of the SIP server 140.

The congestion server 130 to which the call control request message is allocated executes only the processing to return a response message including time information. It is therefore possible to additionally dispose the congestion server 130 at lower cost when compared with a case in which the SIP server 140 is additionally installed.

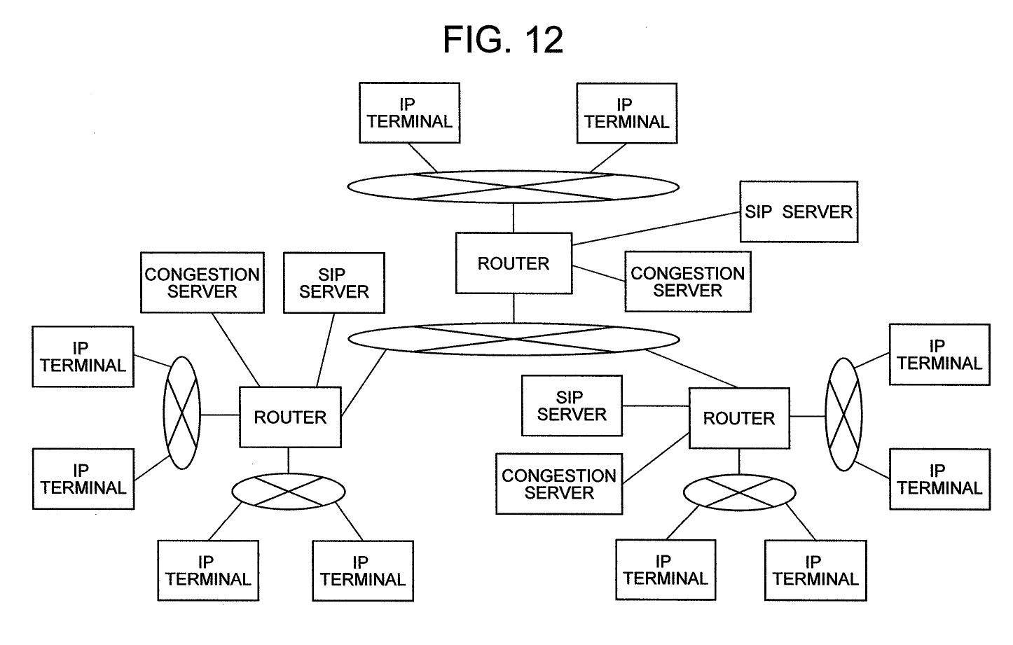

Moreover, for example as FIG. 12 shows, when a plurality of routers 140 execute processing in a distributed fashion, it is possible to control congestion for each smaller particular region. Even if a disaster occurs in an area of, for example, a router 140, ordinary call control can be carried out in any area other than that of the router 140.

Although whether or not a session has been established is controlled by use of Call-Id in the request message of SIP in the embodiment, the present invention is not restricted by the embodiment. It is also possible to use, for example, an IP address and a port number of the source SIP terminal 150 to control the condition.

In the embodiment, since the request message from the router 110 to the congestion server 130 includes information identifying traffic with respect to the SIP server 140, it is possible that time information stored in the congestion notification message from the congestion server 130 is changed according to the magnitude of the traffic. The magnitude of the traffic may be obtained by use of particular threshold values (a plurality of threshold values). The time information stored in the congestion notification message desirably indicates a longer period of time as the magnitude of the traffic with respect to the SIP server 140 is greater.

It should be further understood by those skilled in the art that although the foregoing description has been made on embodiments of the invention, the invention is not limited thereto and various changes and modifications may be made without departing from the spirit of the invention and the scope of the appended claims.

1. A communication system, comprising:
a call control server for conducting call control for a call request from a terminal;
a congestion server; and
a router, wherein:
the router calculates traffic with respect to the call control server, and
the router transfers, if the traffic exceeds a band beforehand set to the call control server at reception of a request message addressed to the call control server from the terminal, the request message to the congestion server; and
the congestion server transmits to the terminal a response message of an error in reply to the request message.

2. A communication system according to claim 1, wherein:
the router stores information identifying a session between the call control server and the terminal; and
the congestion server transmits to the terminal a response message of an error in reply to the request message even in a situation wherein the traffic with respect to the call control server exceeds the band beforehand set to the call control server, if a session has been established between the terminal having issued the request message and the call control server.

3. A communication system according to claim 2, wherein the router assumes that no session has been established between the terminal and the call control server if no communication is conducted between the call control server and the terminal for a predetermined period of time.

4. A communication system according to claim 1, wherein:
the congestion server adds time information determining a predetermined period of time to the request message and sends the message to the terminal; and
the terminal stops transmission of a request message to the call control server for a period of time determined by the time information.

5. A communication system according to claim 4, wherein the period of time determined by the time information changes according to the traffic with respect to the call control server.

6. A router for relaying a request message from a terminal to a call control server, comprising:
a unit for calculating traffic with respect to the call control server; and
a receiving unit for receiving a request message addressed to the call control server from the terminal, wherein
the receiving unit transmits a response message of an error to the terminal in reply to the request message if the traffic with respect to the call control server exceeds a band beforehand set to the call control server at reception of the request message.

7. A router according to claim 6, further comprising:
a unit for storing information identifying a session between the call control server and the terminal; and
a unit for transmitting a response message of an error to the terminal in reply to the request message even in a situation wherein the traffic with respect to the call control server exceeds the band beforehand set to the call control server, if a session has been established between the terminal having issued the request message and the call control server.

8. A router according to claim 7, further comprising a unit for assuming that no session has been established between the terminal and the call control server if no communication is conducted between the call control server and the terminal for a predetermined period of time.
